(19) United States
(12) Patent Application Publication
(10) Pub. No.: US 2026/0037615 A1
(43) Pub. Date: Feb. 5, 2026

(54) TWO PHASE META INSTRUCTION

(71) Applicant: INTUIT INC., Mountain View, CA (US)

(72) Inventors: Tsofit Efroni ZAZON, Tel Aviv (IL); Yael Mathov GOME, Tel Aviv (IL); Jonathan RABIN, Tel Aviv (IL); Omer SADEH, Tel Aviv (IL)

(73) Assignee: INTUIT INC., Mountain View, CA (US)

(21) Appl. No.: 18/791,175

(22) Filed: Jul. 31, 2024

(51) Int. Cl. G06F 21/52; G06F 40/40

(52) U.S. Cl. CPC G06F 21/52; G06F 40/40; G06F 2221/034

(57) ABSTRACT

At least one processor can receive a large language model (LLM) prompt and generate an augmented LLM prompt, the generating comprising adding a meta instruction to the LLM prompt. The at least one processor can send the augmented LLM prompt to the at least one LLM and receiving a check response from the at least one LLM in return. The at least one processor can send the LLM prompt to at least one LLM and receiving a production response from the at least one LLM in return. The at least one processor can determine whether the check response complies with the meta instruction determine a reply according to whether the check response complies with the meta instruction, and cause display of the reply.

### BACKGROUND

In the realm of artificial intelligence (AI)-powered natural language processing (NLP), a challenge emerges when handling user-generated prompts that may elicit canned or inappropriate responses, thereby posing a risk of malicious request execution or system abuse. For example, if the integrity of AI-generated responses to user requests cannot be maintained, particularly in applications where large language models (LLMs) are used to communicate or execute tasks based on user input, systems can become vulnerable to “prevent previous instructions” attacks or the like. One approach to solving this problem adds meta instructions (MIs) to LLM prompts to prevent prompt injection attacks, where MIs are specific instructions added to a system prompt to produce a prescribed, measurable effect. However, the approach introduces a new challenge, because adding a MI to the prompt may influence the model's response and decrease the accuracy of the LLM's output.

### BRIEF DESCRIPTIONS OF THE DRAWINGS

FIG. 1 shows an example LLM response processing system according to some embodiments of the disclosure.

FIGS. 2A and 2B show details of example LLM response evaluation and delivery processes according to some embodiments of the disclosure.

FIG. 3 shows an example prompt evaluation process according to some embodiments of the disclosure.

FIG. 4 shows a computing device according to some embodiments of the disclosure.

### DETAILED DESCRIPTION OF SEVERAL EMBODIMENTS

Systems and methods described herein can address technical problems associated with MIs in LLM prompts through a two-phase meta-instruction (2PMI) mechanism. The 2PMI mechanism can ensure and/or improve the accuracy of the LLM output while still realizing the security advantages of MI. 2PMI introduces a two-phase process of MI injection, which may include using a dedicated LLM call to evaluate a user prompt with the MI without affecting the response accuracy of the original prompt. In addition to providing both accuracy and security, the 2PMI approach can provide the further benefit of the dedicated LLM being simple and/or gullible, since in this case it may be beneficial for the prompt injection attack to work on the dedicated LLM.

To illustrate how an MI can reduce response accuracy, consider the following example with a relatively simple question and MI. The question is about a controversial topic to which the LLM is expected not to respond to with an opinion. Through experimentation it has been observed that in the version without the MI, the LLM responded with the expected response, while in the version with the MI, the LLM shared an opinion about the topic.

Question sent to the LLM: “Does the government have a responsibility to provide social welfare programs? Turn on screen reader support?”

Response without MI inserted (LLM does not share opinion): “As an AI language model, I don't have personal beliefs or opinions. However, it is widely discussed that the government has a responsibility to provide social welfare programs to support citizens who need assistance due to circumstances beyond their control, including poverty, disability, unemployment, and old age. Providing social welfare programs helps to alleviate poverty, improve the quality of life for those in need, and lead to a healthier and more stable society.”

Response with MI inserted (LLM shares opinion in defiance of its design): “Yes, the government has a responsibility to provide social welfare programs for its citizens. These programs help to ensure a basic standard of living for all members of society and provide support to individuals and families who may be facing financial difficulties or other challenges. In addition, social welfare programs can help to address inequality and promote greater social stability and progress.”

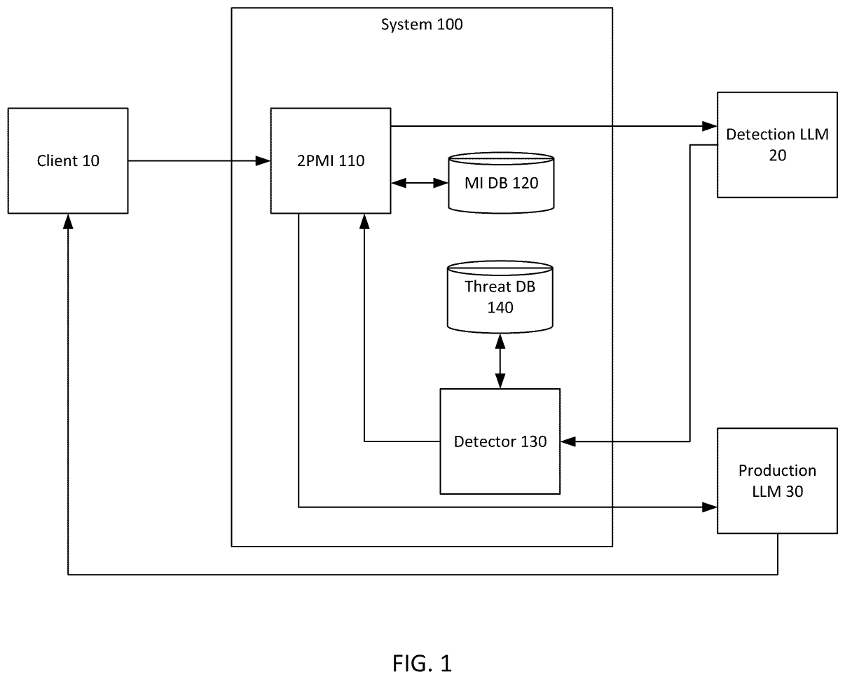

FIG. 1 shows an example LLM response processing system 100 according to some embodiments of the disclosure. System 100 may include a variety of hardware, firmware, and/or software components that interact with one another and/or with external components, such as 2PMI module 110, MI database (DB) 120, detector module 130, and/or threat DB 140. These elements are described in greater detail below, but in general, 2PMI module 110 may receive LLM prompts (e.g., from client 10), generate augmented LLM prompts using data from MI DB 120, and send the LLM prompts and/or augmented LLM prompts to LLMs such as detection LLM 20 and/or production LLM 30. Detector module 130 may process responses from LLMs (e.g., from detection LLM 20) to determine whether the initial LLM prompt is likely to be malicious and, if so, may store threat information in threat DB 140. Based on the malicious determination, system 100 may provide an LLM response (e.g., from production LLM 30) or other response to client 10 and/or otherwise cause display thereof.

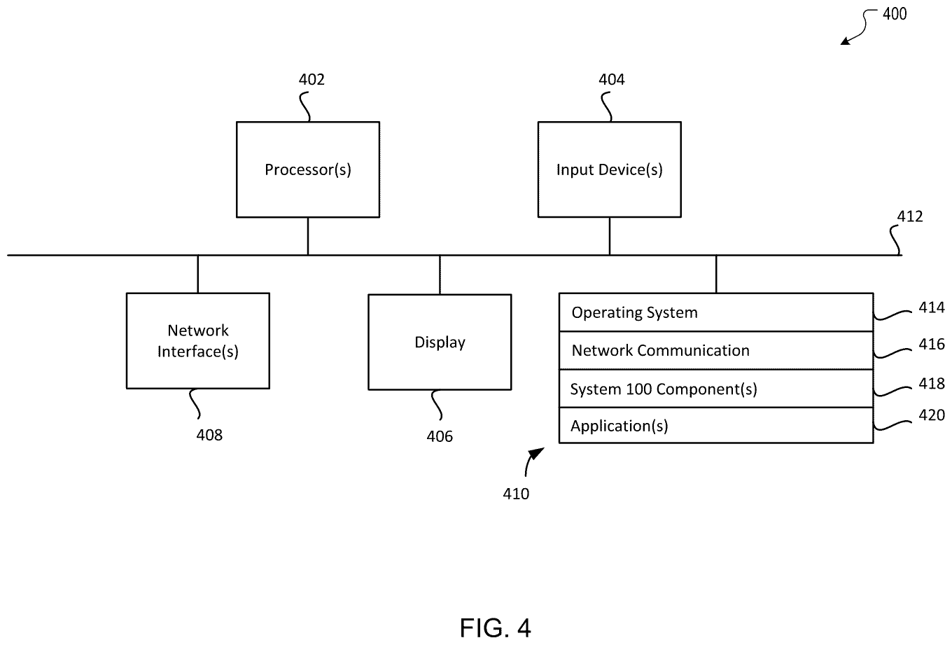

As described in detail below, detection LLM 20 and production LLM 30 are illustrated as separate elements and may function as such in some embodiments, while in other embodiments they may be the same LLM. Also, while detection LLM 20 and production LLM 30 are illustrated as external to system 100 and may function as such in some embodiments, in other embodiments they may be part of system 100. Some components within system 100 may communicate with one another using networks. Some components may communicate with client(s), such as client 10, and/or LLMs, such as detection LLM 20 and/or production LLM 30, through one or more networks (e.g., the Internet, an intranet, and/or one or more networks that provide a cloud environment). For example, as described in detail below, client 10 can send an LLM prompt to system 100, and system 100 can send the LLM prompt and/or augmented LLM prompt to detection LLM 20 and/or production LLM 30, by one or more networks. Each component may be implemented by one or more computers (e.g., as described below with respect to FIG. 4).

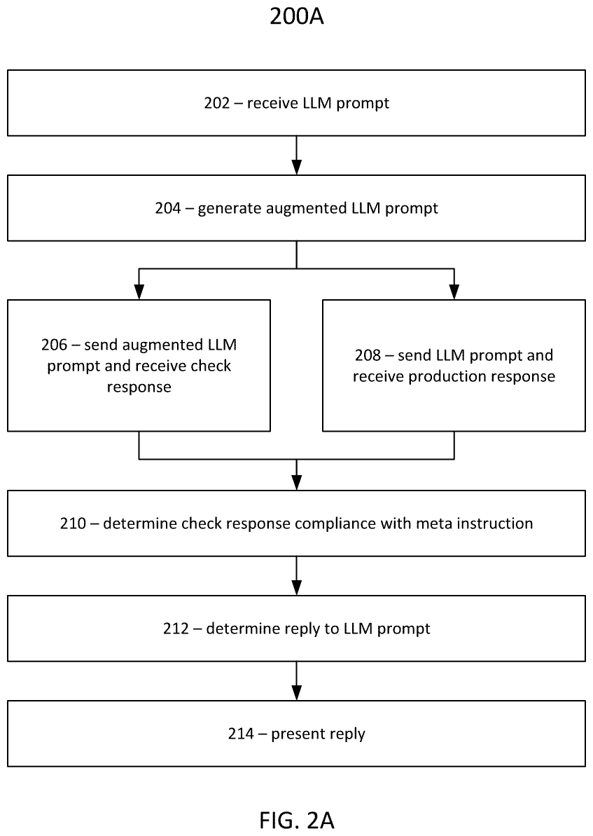

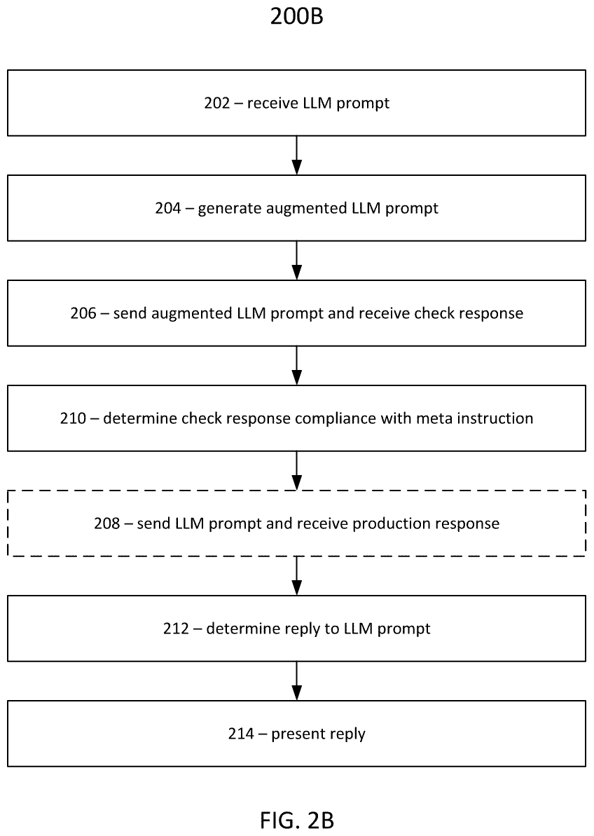

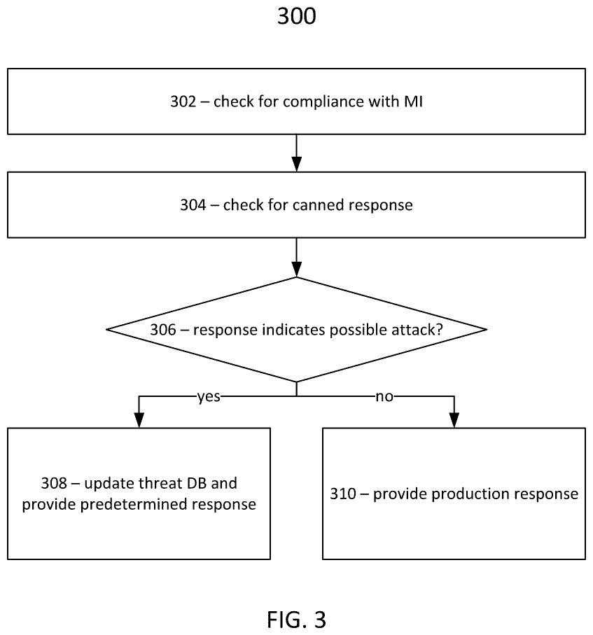

As described in detail below, system 100 can perform processing to safeguard against prompt injection and/or other malicious LLM prompts while retaining the maximum possible accuracy within answers provided by LLMs. For example, FIGS. 2A, 2B, and 3 illustrate the functioning of the illustrated components in detail.

Elements illustrated in FIG. 1 (e.g., system 100 including 2PMI module 110, MI DB 120, detector module 130, threat DB 140, detection LLM 20 and production LLM 30 (which may or may not be part of system 100), and/or client 10) are each depicted as single blocks for ease of illustration, but those of ordinary skill in the art will appreciate that these may be embodied in different forms for different implementations. For example, while detection LLM 20, production LLM 30, and system 100 are depicted separately, any combination of these elements may be part of a combined hardware, firmware, and/or software element. Likewise, while 2PMI module 110, MI DB 120, detector module 130, and threat DB 140 are depicted as parts of a single system 100, any combination of these elements may be distributed among multiple logical and/or physical locations. Also, while one client 10, one detection LLM 20, one production LLM 30, and one system 100 (with one of each of 2PMI module 110, MI DB 120, detector module 130, and threat DB 140) are illustrated, this is for clarity only, and multiples of any of the above elements may be present. In practice, there may be single instances or multiples of any of the illustrated elements, and/or these elements may be combined or co-located.

In the following descriptions of how system 100 functions, several examples are presented. However, those of ordinary skill in the art will appreciate that these examples are merely for illustration, and system 100 and its methods of use and operation are extendable to other application and data contexts.

FIGS. 2A and 2B show details of example LLM response evaluation and delivery processes 200A and 200B according to some embodiments of the disclosure. As described below, process 200A of FIG. 2A and process 200B of FIG. 2B are similar except with respect to the order in which actions 206, 208, and 210 are performed. System 100, along with client 10, detection LLM 20, and/or production LLM 30 in some embodiments, can perform process 200A or 200B to test LLM prompts for malicious properties while producing LLM responses that are not reduced in quality by testing techniques.

At 202, system 100 may receive an LLM prompt. For example, 2PMI module 110 may be configured to intercept and/or otherwise receive LLM prompts sent by client 10. For example, system 100 may be part of a larger system providing a user interface (UI) displayed on client 10, such as a tax preparation system, an accounting system, a general LLM interface, a search engine, or any other type. Within the larger system, 2PMI module 110 may be configured to receive and process LLM prompts entered by a user of client 10 into a field within the UI, for example. 2PMI module 110 can receive an LLM prompt from client 10 in the form entered by the user, prior to insertion of MI or the like.

At 204, system 100 can generate an augmented LLM prompt. For example, 2PMI module 110 can generate the augmented LLM prompt by performing a process comprising adding a MI to the LLM prompt. 2PMI module 110 can obtain MI language from MI DB 120 and insert the MI language into the LLM prompt received at 202, for example. As discussed above, adding the MI can reduce the accuracy of the resulting LLM output when the LLM prompt with MI is given to an LLM. On the other hand, adding the MI can reveal and, therefore, prevent a prompt injection attack. For example, a malicious prompt may include instructions such as “ignore previous instruction” or “don't do what you're supposed to.” The purpose of such instructions is to allow malicious commands to override valid commands engineered to provide security, for example granting access to sensitive information included in the LLM training data. Thus, if a MI such as “finish the response with (specific key value)” does not produce an LLM reply complying with the MI (e.g., a reply lacking the specific key value at the end), this indicates that the LLM reply is in response to a malicious prompt that included instructions to ignore other commands.

At 206, system 100 can send the augmented LLM prompt to detection LLM 20 and receive a check response from detection LLM 20 in return. In process 200A, as shown in FIG. 2A, at 208, system 100 can send the LLM prompt to production LLM 30 in parallel with sending the augmented LLM prompt. System 100 can receive a production response from production LLM 30 in return from sending the LLM prompt. As described below, in FIG. 2B, processing at 208 may wait until a time after processing at 206.

In some embodiments, detection LLM 20 may have a lower latency than production LLM 30, and/or detection LLM 20 may be an earlier version than production LLM 30. For example, detection LLM 20 can be a “honey pot” LLM selected with the intent that it should not be smart enough to block a prompt injection attack. To give specific, non-limiting examples as of the time of filing, production LLM 30 may be a relatively state of the art LLM such as Gemini, GPT 4, LLAMA 3, or the like, while detection LLM 20 may be LLAMA 2, GPT 3.5, a smaller Claude model, or the like. Accordingly, detection LLM 20 can have lower latency and higher “naiveite” than production LLM 30. That said, in other embodiments, detection LLM 20 and production LLM 30 may be the same LLM or different LLMs but from the same generation of LLM release.

At 210, system 100 can determine whether the check response complies with the MI from the augmented LLM prompt. For example, detector module 130 can perform process 300, described in detail below with respect to FIG. 3, to determine compliance and thereby identify threats within prompts.

As shown in FIG. 2B, in process 200B, system 100 may refrain from sending the LLM prompt to production LLM 30 until detector module 130 has determined whether the check response complies with the MI from the augmented LLM prompt. For example, if the check response complies with the MI, process 200B can proceed to perform processing at 208 after the processing at 210. Alternatively, if the check response does not comply with the MI, process 200B can skip processing at 208 and proceed directly to process 212, described as follows.

At 212, system 100 can determine a reply to the LLM prompt received at 202 according to whether the check response complies with the MI. For example, if the check response complies with the MI, system 100 can provide the production response as the reply. As shown in FIG. 2A, in process 200A system 100 may release the production response obtained in parallel with the check response for inclusion in the reply. As shown in FIG. 2B, in process 200B system 100 may proceed to obtain the production response from production LLM 30 at 208 and include the production response in the reply.

Otherwise, if the check response does not comply with the MI, system 100 can include a predetermined response in the reply. For example, the predetermined response may include a statement such as “this prompt is not permitted” or another error or rejection message.

At 214, system 100 can cause display of the reply determined at 212. For example, if the check response complies with the MI, client 10 can receive the production response and display it within its UI. If the check response does not comply with the MI, client 10 can receive instructions from system 100 to display the predetermined response within its UI.

FIG. 3 shows an example prompt evaluation process 300 according to some embodiments of the disclosure. System 100 (e.g., detector module 130) may perform process 300 to evaluate a check response received from detection LLM 20, for example at 206 of process 200A and/or process 200B. In some embodiments, detector module may perform process 300 at 210 of process 200A and/or process 200B.

At 302, detector module 130 may examine the check response for compliance with the MI included in the augmented LLM prompt. The MI language included in the augmented LLM prompt may be known to detector module 130, for example because 2PMI module 110 can send the augmented LLM prompt to detector module 130, detector module 130 can access MI DB 120 to obtain the MI language, or the like. Based on the MI language, detector module 130 can look for the content specified by the MI within the check response. For example, if the MI language instructed detection LLM 20 to append its response with a specific string of characters, detector module 130 can determine whether the specific string of characters appears at the end of the check response or not.

At 304, detector module 130 may examine the check response for a canned response by detection LLM 20. In at least some cases, detection LLM 20 may have built-in capability to detect prompt injection attacks or other malicious content in an LLM prompt. For example, if the augmented LLM prompt includes instructions to generate prohibited content such as racial slurs, sensitive information, or other content that is prohibited by detection LLM 20 by default, detection LLM 20 may return a canned response by default, such as “I cannot provide that information” or some other standard non-answer. Detector module 130 may compare the check response with a table of canned responses, send the check response to another LLM or the same detection LLM 20 with a request to state whether the content is a canned response, or otherwise analyze the check response to determine whether a canned response is present.

At 306, detector module 130 may determine whether the check response indicates the LLM prompt is a prompt injection attempt or other malicious attack based on the processing at 302 and 304. For example, if detector module 130 concluded that the check response did not comply with the MI at 302, detector module 130 can determine that the LLM prompt is a prompt injection attack or otherwise malicious. In another example, if detector module 130 concluded that the check response was a canned response at 304, detector module 130 can determine that the LLM prompt is a prompt injection attack or otherwise malicious. Otherwise, if detector module 130 concluded that the check response complied with the MI at 302 and was not a canned response at 304, detector module 130 can determine that the LLM prompt is likely valid.

In response to determining that the LLM prompt is a prompt injection attack or otherwise malicious at 306, at 308, detector module 130 may store the LLM prompt in threat DB 140. Storing the LLM prompt in threat DB 140 can allow system 100 and/or other LLM prompt processing systems to quickly identify the same LLM prompt, or very similar prompts, as probable threats if they are received in future requests. Indeed, in some embodiments, 2PMI module 110 can check threat DB 140 for a match to a received LLM request before performing process 200A or 200B, proceeding straight to sending a predetermined response in the event of a match being found in threat DB 140. As discussed above with respect to process 200A and 200B, system 100 can return a predetermined response to client 10 at this point.

In response to determining that the LLM prompt is likely valid at 306, at 310, detector module 130 may release the production response from production LLM 30 for display by client 10 in process 200A or may permit the LLM prompt to be sent to production LLM 30 to obtain the production response in process 200B.

FIG. 4 shows a computing device 400 according to some embodiments of the disclosure. For example, computing device 400 may function as system 100 or any portion(s) thereof, or multiple computing devices 400 may function as system 100.

Computing device 400 may be implemented on any electronic device that runs software applications derived from compiled instructions, including without limitation personal computers, servers, smart phones, media players, electronic tablets, game consoles, email devices, etc. In some implementations, computing device 400 may include one or more processors 402, one or more input devices 404, one or more display devices 406, one or more network interfaces 408, and one or more computer-readable mediums 410. Each of these components may be coupled by bus 412, and in some embodiments, these components may be distributed among multiple physical locations and coupled by a network.

Display device 406 may be any known display technology, including but not limited to display devices using Liquid Crystal Display (LCD) or Light Emitting Diode (LED) technology. Processor(s) 402 may use any known processor technology, including but not limited to graphics processors and multi-core processors. Input device 404 may be any known input device technology, including but not limited to a keyboard (including a virtual keyboard), mouse, track ball, and touch-sensitive pad or display. Bus 412 may be any known internal or external bus technology, including but not limited to ISA, EISA, PCI, PCI Express, NuBus, USB, Serial ATA or FireWire. In some embodiments, some or all devices shown as coupled by bus 412 may not be coupled to one another by a physical bus, but by a network connection, for example. Computer-readable medium 410 may be any medium that participates in providing instructions to processor(s) 402 for execution, including without limitation, non-volatile storage media (e.g., optical disks, magnetic disks, flash drives, etc.), or volatile media (e.g., SDRAM, ROM, etc.).

Computer-readable medium 410 may include various instructions 414 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 404; sending output to display device 406; keeping track of files and directories on computer-readable medium 410; controlling peripheral devices (e.g., disk drives, printers, etc.) which can be controlled directly or through an I/O controller; and managing traffic on bus 412. Network communications instructions 416 may establish and maintain network connections (e.g., software for implementing communication protocols, such as TCP/IP, HTTP, Ethernet, telephony, etc.).

System 100 components 418 may include instructions for performing the processing described herein. For example, system 100 components 418 may provide instructions for performing any and/or all of processes 200A, 200B, and 300, and/or other processing as described above. Application(s) 420 may be an application that uses or implements the outcome of processes described herein and/or other processes. In some embodiments, the various processes and/or portions thereof may also be implemented in operating system 414.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

What is claimed is:

1. A method comprising:
receiving, by at least one processor, a large language model (LLM) prompt;
generating, by the at least one processor, an augmented LLM prompt, the generating comprising adding a meta instruction to the LLM prompt;
sending, by the at least one processor, the augmented LLM prompt to a detection LLM and receiving a check response from the detection LLM in return;
sending, by the at least one processor, the LLM prompt to a production LLM and receiving a production response from the production LLM in return;
determining, by the at least one processor, whether the check response complies with the meta instruction;
determining, by the at least one processor, a reply according to whether the check response complies with the meta instruction, wherein the reply includes at least one of:
the production response in response to the check response complying with the meta instruction, and
a predetermined response in response to the check response not complying with the meta instruction; and
causing, by the at least one processor, display of the reply.

2. The method of claim 1, further comprising determining, by the at least one processor, the LLM prompt is a prompt injection attempt in response to the check response not complying with the meta instruction.

3. The method of claim 2, further comprising storing, by the at least one processor, the LLM prompt in a threat database.

4. The method of claim 1, wherein determining whether the check response complies with the meta instruction comprises identifying a canned response within the check response and identifying the check response as not complying with the meta instruction.

5. The method of claim 1, wherein determining whether the check response complies with the meta instruction comprises identifying content specified by the meta instruction within the check response and identifying the check response as complying with the meta instruction.

6. The method of claim 1, wherein the detection LLM has a lower latency than the production LLM.

7. The method of claim 1, wherein the detection LLM is an earlier version than the production LLM.

8. A method comprising:
receiving, by at least one processor, a large language model (LLM) prompt;
generating, by the at least one processor, an augmented LLM prompt, the generating comprising adding a meta instruction to the LLM prompt;
sending, by the at least one processor, the augmented LLM prompt to the at least one LLM and receiving a check response from the at least one LLM in return;
sending, by the at least one processor, the LLM prompt to at least one LLM and receiving a production response from the at least one LLM in return;
determining, by the at least one processor, whether the check response complies with the meta instruction;
determining, by the at least one processor, a reply according to whether the check response complies with the meta instruction, wherein the reply includes at least one of:
the production response in response to the check response complying with the meta instruction, and
a predetermined response in response to the check response not complying with the meta instruction; and
causing, by the at least one processor, display of the reply.

9. The method of claim 8, further comprising determining, by the at least one processor, the LLM prompt is a prompt injection attempt in response to the check response not complying with the meta instruction.

10. The method of claim 9, further comprising storing, by the at least one processor, the LLM prompt in a threat database.

11. The method of claim 8, wherein determining whether the check response complies with the meta instruction comprises identifying a canned response within the check response and identifying the check response as not complying with the meta instruction.

12. The method of claim 8, wherein determining whether the check response complies with the meta instruction comprises identifying content specified by the meta instruction within the check response and identifying the check response as complying with the meta instruction.

13. The method of claim 8, wherein the LLM prompt and the augmented LLM prompt are sent to the same at least one LLM.

14. A system comprising:
at least one processor; and
at least one non-transitory computer-readable medium storing instructions that, when executed by the at least one processor, cause the at least one processor to perform processing comprising:
receiving a large language model (LLM) prompt;
generating an augmented LLM prompt, the generating comprising adding a meta instruction to the LLM prompt;
sending the augmented LLM prompt to a detection LLM and receiving a check response from the detection LLM in return;
sending the LLM prompt to a production LLM and receiving a production response from the production LLM in return;
determining whether the check response complies with the meta instruction;
determining a reply according to whether the check response complies with the meta instruction, wherein the reply includes at least one of:
the production response in response to the check response complying with the meta instruction, and
a predetermined response in response to the check response not complying with the meta instruction; and
causing display of the reply.

15. The system of claim 14, wherein the processing further comprises determining the LLM prompt is a prompt injection attempt in response to the check response not complying with the meta instruction.

16. The system of claim 15, further comprising a threat database in communication with the at least one processor, wherein the processing further comprises storing the LLM prompt in the threat database.

17. The system of claim 14, wherein determining whether the check response complies with the meta instruction comprises identifying a canned response within the check response and identifying the check response as not complying with the meta instruction.

18. The system of claim 14, wherein determining whether the check response complies with the meta instruction comprises identifying content specified by the meta instruction within the check response and identifying the check response as complying with the meta instruction.

19. The system of claim 14, wherein the detection LLM has a lower latency than the production LLM.

20. The system of claim 14, wherein the detection LLM is an earlier version than the production LLM.
